(19) United States
(12) Patent Application Publication
(10) Pub. No.: US 2002/0091551 A1
(43) Pub. Date: Jul. 11, 2002

(54) Internet insurance product

(76) Inventor: Robert Parisi, Pelham, NY (US)

Correspondence Address: PROSKAUER ROSE, 1585 BROADWAY, NEW YORK, NY, 100368299

(21) Appl. No.: 09/955,746

(22) Filed: Sep. 18, 2001

Related U.S. Application Data
(60) Provisional application No. 60/233,503, filed on Sep. 19, 2000.

(51) Int. Cl. G06F 17/60

(52) U.S. Cl. 705/4

(57) ABSTRACT

An Internet insurance product provides risk management for persons who conduct business on the Internet. This insurance product includes a suite of different Internet-related coverages, from which a purchaser can select an appropriate combination of insurance protections. These coverages include content-related liability, errors and omissions, E-business interruption, network security, and third party liability, among others, thereby providing comprehensive protection for a broad range of Internet-related security and liability exposures.

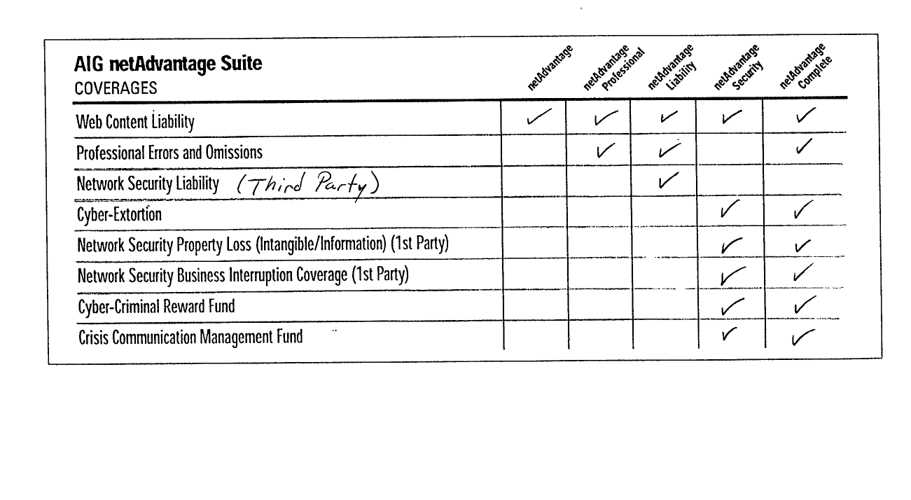

### BACKGROUND OF THE INVENTION

The present invention relates to an insurance product for the Internet. More specifically, the present invention relates to an insurance product that includes a suite of different Internet-related coverages for persons who conduct business on the Internet.

Numerous types of insurance plans are available for traditional brick-and-mortar companies, which include coverages for property, casualty and business interruption exposures. In the world of E-commerce, however, there are many new types of risks that are not covered by traditional insurance policies. Such Internet-related risks can include:

a. Web Content liability claims;

b. Loss of “intangible” information assets;

c. E-business interruption;

d. Errors and omissions litigation;

e. Cyber-extortion; and

f. Network security failures.

This new universe of cyberspace risks can lead to devastating problems for an unprotected E-commerce company, and can take a heavy toll on the company's profitability, brand identification, corporate image and stock value.

In order to protect against such risks, new types of insurance products are needed, which relate specifically to Internet liability. Ideally, a suite of protective policies can be created, to cover every type of Internet-related risk. A client can then choose any or all of the coverages available, to suit his particular requirements.

For example, an insurance suite can provide the following types of coverage:

a. Web content protection;

b. Professional liability insurance;

c. Third-party liability protection; and

d. Comprehensive solutions for identifying, managing and mitigating diverse network security and liability exposures.

With this type of insurance suite, a company can choose the precise Internet liability protection it needs to address its specific Internet-related risks, whatever its level of cyber-activity.

Accordingly, it is an object of the present invention to define a suite of Internet insurance products that can protect an E-business from any or all of the aforementioned Internet-related risks.

### SUMMARY OF THE INVENTION

In accordance with an illustrative embodiment of the present invention, an insurance product is disclosed which covers the risks associated with conducting business on the Internet. This insurance product is comprised of five different policies, which may be purchased individually, or in any combination. The five policies are summarized as follows:

a. a first insurance policy for conducting advertising and marketing business on the Internet;

b. a second insurance policy for rendering professional services on the Internet;

c. a third insurance policy for protection against a third party liability when conducting business on the Internet;

d. a fourth insurance policy for network security when conducting business on the Internet; and

e. a fifth insurance policy which encompasses all of the coverages of the aforementioned first, second and fourth policies.

### BRIEF DESCRIPTION OF THE DRAWING

The invention is described in greater detail below through the example of embodiments shown in the drawing, wherein the sole FIGURE displays a chart of insurance coverages and their corresponding policies, in accordance with the invention.

### DETAILED DESCRIPTION OF PREFERRED EMBODIMENTS OF THE INVENTION

The present invention is comprised of a suite of insurance products, which cover the following risk categories:

a. Web Content Liability

b. Professional Errors and Omissions

c. Network Security Liability (Third Party)

d. Cyber-Extortion

e. Network Security Property loss (Intangible/Information) (First Party)

f. Network Security Business Interruption Coverage (First Party)

g. Cyber-Criminal Reward Fund

h. Crisis Communication Management Fund

The inventive suite of insurance products is identified herein as “AIGnetAdvantage^{SM} Suite”, and is organized into five major policies, each of which is designed for a particular type of E-business protection, as shown in the sole FIGURE. The five policies and their primary coverages are:

1. AIGnetAdvantage^{SM}—for companies that use the Internet for advertising and marketing activities;

2. AIGnetAdvantage Professional^{SM}—for companies rendering professional services via the web, or serving e-clients;

3. AIGnetAdvantage Liability^{SM}—an extensive third-party Internet liability coverage for any company using the Internet;

4. AIGnetAdvantage Security^{SM}—robust protection for web content and network security risks for any company using the Internet;

5. AIGnetAdvantage Complete^{SM}—total protection for web content, professional services and network security for any company using the Internet.

These five policies, which make up the inventive AIGnetAdvantages^{SM} Suite, are described more fully below.

1. AIGnetAdvantages^{SM}

This policy is designed expressly for any company that uses its web site for marketing or advertising, whether it posts its own brochureware or another company's banner advertisement. As one consequence of a company displaying or disseminating this type of content on its web site, there is a risk of potential lawsuits, which can involve a range of allegations, such as defamation, libel, slander, copyright or trademark infringement, and invasion of privacy.

To protect against the aforementioned risks, AIGnetAdvantages^{SM} includes:

a. A broad grant of coverage, including advertising and webcasting, as well as material published, transmitted, disseminated, distributed, serialized, created, originated, exhibited or displayed via the web in the course of business.

b. Worldwide coverage.

c. An occurrence based form.

d. An expansive definition of covered wrongful act that includes allegations of libel, slander, product disparagement, trade libel; infringement of copyright, title, slogan, trademark, domain name, trade name, trade dress or service name; plagiarism, piracy or misappropriation of ideas under implied contract; and invasion, infringement or interference with rights of privacy or publicity. It also includes disclosure of private facts and commercial misappropriation of name or likeness.

e. A broad definition of claim that includes demands for money, services, non-monetary or injunctive relief, as well as civil, criminal or arbitration proceedings.

f. Coverage for punitive, exemplary and multiple damage awards, where permitted by law.

g. Flexibility in controlling claims. The insured can settle claims within the retention without the insurer's approval.

h. The services of the insurer's Counsel, specializing in technology-related litigation.

i. Limits up to $25 million, and retentions as low as $2,500.

2. AIGnetAdvantage Professionals™

This policy is designed for companies that render professional services via the web, or provide Internet-related professional services. It also includes the protections for Internet marketing and advertising risks found in AIGnetAdvantages^{SM}. The insurance coverages provided by AIGnetAdvantage Professional^{SM} include:

a. Broad-based claims-made errors and omission coverage for Internet and professional liability.

b. Worldwide coverage.

c. A broad definition of wrongful acts, actual or alleged, in the performance of Internet professional services, including technology and media products and services.

d. Customized coverage to address the needs of any profession utilizing the web.

e. A broad definition of claim that includes demands for money, services, non-monetary or injunctive relief, as well as civil, criminal or arbitration proceedings.

f. Coverage for punitive, exemplary and multiple damage awards, where permitted by law.

g. Broad coverage for content-based liability, as well as for liability assumed under contract arising from the insured's Internet media and services, including trademarked and copyrighted software.

h. Flexibility in controlling claims. The insured can settle claims within the retention without the insurer's approval.

i. The services of the insurer's Counsel, specializing in technology-related litigation.

j. Limits up to $25 million.

3. AIGnetAdvantage Liability™

This policy is designed to provide extensive third-party liability coverage for companies using the Internet, including the liabilities they can face when the services they provide, the content they publish, or a breach of their network security, results in harm to a third party. The AIGnetAdvantage Liability™ policy includes:

a. Liability coverage for claims that result when failure of the insured's security causes unauthorized use or access (i.e., a computer attack), disclosure of confidential or private information, transmission of a computer virus, or denial of service to customers or clients.

b. Occurrence based Media coverage for claims alleging content-based injuries such as libel, slander or defamation; copyright, title or trademark infringement; or invasion of privacy.

c. Broad based claims made errors and omissions policy for Internet and professional liability.

d. Worldwide coverage.

e. Coverage that encompasses claims for monetary, non-monetary or injunctive relief.

f. Punitive, exemplary and multiple damage awards, as permitted by law.

g. Flexibility in controlling claims. The insured can settle claims within the retention without the insurer's approval.

h. The services of the insurer's Counsel, specializing in technology-related litigation.

i. Limits up to $25 million.

4. AIGnetAdvantage Securitys™

This policy provides insurance coverages for web site content and network security risks for any company using the Internet. Importantly, these coverages provide protection against “cyber-attacks”, which can emanate from internal or external sources, and may be intentional or accidental. The AIGnetAdvantage Securitys™ policy includes:

a: Media Liability coverage for claims alleging content-based injuries, such as libel, slander or defamation; copyright, title or trademark infringement; or invasion of privacy.

b. Security Liability coverage for claims that result when failure of the insured's network security causes a denial of services to customers or clients, unauthorized use or access (i.e., a computer attack), disclosure of confidential or private information, or transmission of a computer virus.

c. Asset Protection coverage, which provides first party insurance for property losses involving intangible assets, such as credit card numbers, customer lists, and business strategies resulting from a network security failure.

d. Income Protection coverage also includes e-Business interruption and extra expense costs (including dependent business interruption up to $100,000) resulting from a network security failure.

e. Extortion coverage for both investigation and “settlement” of bona fide cyber-attack threats.

f. Computer Attack Reward Coverage, which provides up to $50,000 (with no retention) for information that leads to the arrest and conviction of any individual committing or attempting to commit a computer attack or other criminal act under the policy.

g. Crisis Communications Management Insurance, which provides up to $50,000 (with no retention) toward the fees and expenses of public relations or crisis management firms, to help insureds respond effectively to a covered Computer Crisis Management Event.

h. Worldwide Coverage.

i. Coverage for a wide variety of computer attacks, including denial of service, as a result of worms, viruses, etc.

j. A broad definition of claim that includes demands for money, services, non-monetary or injunctive relief, as well as civil, criminal or arbitration proceedings.

k. Punitive, exemplary and multiple damage awards, where permitted by law.

l. An expansive definition of Insured that encompasses the company, its directors, officers, employees, trustees, subsidiaries, and, for media-related claims, certain independent contractors and agents.

m. Coverage for losses that arise from “social engineering” theft of computer passwords or access codes, and from failure of the insured's network security hardware, software and firmware.

n. Flexibility in controlling claims. The insured can settle claims within the retention without the insurer's approval.

o. The services of the insurer's Counsel, specializing in technology-related litigation.

p. Automatic and optional extended reporting periods.

q. Limits up to $25 million.

5. AIGnetAdvantage Completes™

This policy is designed to combine all the features of the aforementioned AIGnetAdvantage™, AIGnetAdvantage Professionals™, and AIGnetAdvantage Security™, to provide comprehensive coverage for claims arising from computer virus transmission, unauthorized access, loss of service, and essential protection for Internet media and e-Commerce related exposures. The AIGnetAdvantage Completes™ policy includes:

a. Liability coverage for claims that result when failure of the insured's security causes unauthorized use or access (i.e., a computer attack), disclosure of confidential or private information, transmission of a computer virus or denial of service to customers or clients.

b. Media coverage for claims alleging content-based injuries such as libel, slander or defamation; copyright, title or trademark infringement; or invasion of privacy.

c. Broad based claims made errors and omissions policy for Internet and professional liability.

d. Asset and Income Protection coverage, which provides first-party insurance for property losses involving intangible assets, such as credit card numbers, customer lists, and business strategies. Coverage also includes e-Business interruption and Internet extra expense costs (including dependent business interruption up to $100,000), where permitted by law.

e. Computer Attack Reward Coverage, which provides up to $50,000 (with no retention) for information that leads to the arrest and conviction of any individual committing or attempting to commit a computer attack or other criminal act under the policy.

f. Crisis Communications Management Insurance, which provides up to $50,000 (with no retention) toward the fees and expenses of public relations or crisis.

g. Coverage that encompasses claims for monetary, non-monetary or injunctive relief.

h. Punitive, exemplary and multiple damage awards, where permitted by law.

i. Flexibility in controlling claims. The insured can settle claims within the retention without the insurer's approval.

j. The services of the insurer's Counsel, specializing in technology-related litigation.

k. Limits up to $25 million.

In short, a novel Internet insurance product is disclosed, which provides risk management for persons who conduct business on the Internet. The inventive insurance product includes a suite of different Internet-related coverages, from which a purchaser can select the appropriate protections to address his/her particular needs.

While the invention has been described by reference to specific embodiments, this was for purposes of illustration only and should not be construed to limit the scope of the invention. Numerous alternative embodiments will be apparent to those skilled in the art.

1. An insurance product to cover the risks associated with conducting business on the Internet, comprising:
a. a first insurance coverage for conducting advertising and marketing business on the Internet,
b. a second insurance coverage for rendering professional services on the Internet,
c. a third insurance coverage for protection against a third party liability when conducting business on the Internet,
d. a fourth insurance coverage for network security when conducting business on the Internet, and
e. a fifth insurance coverage which combines the protections provided by said first, second and fourth insurance coverages.

2. The insurance product of claim 1 wherein said first insurance coverage comprises protection for material published, transmitted, disseminated, distributed, serialized, created, originated, exhibited or displayed via the Internet in the course of business.

3. The insurance product of claim 2 wherein said first insurance coverage further comprises protection for alleged wrongful acts, including libel, slander, product disparagement and trade libel, as well as infringement of copyright, title, slogan, trademark, domain name, trade name, trade dress or service name, and also plagiarism, piracy, misappropriation of ideas under implied contract, and invasion, infringement and interference with rights of privacy and publicity.

4. The insurance product of claim 1 wherein said second insurance coverage comprises protection for errors and omissions, and for content-based liability.

5. The insurance product of claim 4 wherein said second insurance coverage further comprises protection for allegations of wrongful acts in the performance of professional services on the Internet.

6. The insurance product of claim 1 wherein said third insurance coverage comprises protection against a third party liability when a failure of network security causes damage to said third party.

7. The insurance product of claim 1 wherein said fourth insurance coverage comprises protection against a network security failure caused by a cyber-attack, including coverages for denial of services, loss of intangible assets, E-business interruption, cyber-extortion, computer attack reward, and crisis management.

8. The insurance product of claim 1 wherein said first, second, third, fourth and fifth insurance coverages are worldwide.

9. The insurance product of claim 1 wherein said first, second, third, fourth and fifth insurance coverages can be purchased individually or in any combination.
